(19) United States
(12) Patent Application Publication
(10) Pub. No.: US 2020/0343581 A1
(43) Pub. Date: Oct. 29, 2020

(54) ELECTROLYTE SOLUTION FOR LITHIUM ION SECONDARY BATTERY, AND LITHIUM ION SECONDARY BATTERY

(71) Applicant: MAZDA MOTOR CORPORATION, Hiroshima (JP)

(72) Inventors: Hiroki FUJITA, Aki-gun, Hiroshima (JP); Hiroyuki SAKAI, Aki-gun, Hiroshima (JP); Wataru MASUDA, Aki-gun, Hiroshima (JP)

(73) Assignee: MAZDA MOTOR CORPORATION, Hiroshima (JP)

(21) Appl. No.: 16/959,641

(22) PCT Filed: Jan. 9, 2019
(86) PCT No.: PCT/JP2019/000362

§ 371 Date: Jul. 1, 2020

(30) Foreign Application Priority Data
Jan. 10, 2018 (JP) 2018-002218
Jan. 9, 2019 (JP) 2019-001688

(51) Int. Cl. H01M 10/0525; H01M 10/0569; H01M 10/0563; H01M 10/0568; H01M 4/587

(52) U.S. Cl. CPC H01M 10/0525; H01M 10/0569; H01M 2300/0037; H01M 10/0568; H01M 4/587; H01M 10/0563

(57) ABSTRACT

An electrolyte to be used in a lithium ion secondary battery that contains a graphite-based carbon material as a negative electrode active material is obtained by dissolving a lithium salt in a nonaqueous solvent. The nonaqueous solvent contains a cyclic carbonate and a cyclic ester. The proportion of the sum of the cyclic carbonate and the cyclic ester in the total amount of the nonaqueous solvent is 85 vol % or more. The proportion of the cyclic carbonate in the sum of the cyclic carbonate and the cyclic ester is 60 vol % or more to 95 vol % or less.

### TECHNICAL FIELD

The present invention relates to an electrolyte for a lithium ion secondary battery and a lithium ion secondary battery.

### BACKGROUND ART

A lithium ion secondary battery mainly includes: a positive electrode and a negative electrode which store and release lithium; a nonaqueous electrolyte; and a separator, and is used, for example, in electronic devices such as mobile phones and personal computers, and electronic vehicles. The nonaqueous electrolyte is obtained by dissolving a lithium salt in a nonaqueous solvent such as ethylene carbonate, propylene carbonate, and dimethyl carbonate. Such lithium ion secondary batteries involve problems of volatilization of flammable nonaqueous solvents and release of oxygen due to degradation of a lithium composite oxide used as a positive electrode active material at high temperatures.

In order to solve these problems, Patent Document 1 indicates that a polyanionic material having a high dissociation temperature of oxygen is used as a positive electrode active material, that Li₄Ti₅O₁₂, SiO, or the like, which is less likely to generate Li dendrite compared to graphite is used as a negative electrode active material, and that an organic solvent having a high boiling point, such as propylene carbonate, ethylene carbonate, and butylene carbonate is used as a nonaqueous solvent. Patent Document 1 further indicates that lithium iron phosphate is used as a positive electrode active material, that SiO is used as a negative electrode active material, and that a solvent mixture of propylene carbonate and γ-butyrolactone in a volume ratio of 1:2 is used as a nonaqueous solvent of electrolyte.

### CITATION LIST

### Patent Document

PATENT DOCUMENT 1: Japanese Unexamined Patent Publication No. 2013-84521

### SUMMARY OF THE INVENTION

### Technical Problem [0005]

The electronic devices and electronic vehicles may be used not only at high temperatures in the mid-summer, but also under extreme cold conditions where temperatures become −30° C. or less in winter. Therefore, lithium ion secondary batteries incorporated in such electronic devices and electronic vehicles are required to exhibit high charge-discharge performance in a wide temperature range from a high temperature to a cryogenic temperature.

If Li₄Ti₅O₁₂, which has higher electric potential than graphite, is used as a negative electrode active material as in Patent Document 1, the battery capacity or input and output decrease due to the high electric potential. Further, a higher boiling point of the nonaqueous solvent is advantageous in ensuring the heat resistance of the battery but does not always improve the performance of the battery at low temperatures. For example, there is a concern that an increase in resistance due to coagulation of the electrolyte may occur at low temperatures such as −30° C.

Therefore, an object of the present invention is to obtain a lithium ion secondary battery that reduces volatilization of a flammable nonaqueous solvent, and exhibits a high charge-discharge performance in a wide temperature range from a low temperature to a high temperature.

### Solution to the Problem

In order to solve the problems described above, in the present invention, a solvent mixture of propylene carbonate and γ-butyrolactone is used as a nonaqueous solvent, and a graphite-based carbon material is used as a negative electrode active material.

An electrolyte for a lithium ion secondary battery disclosed herein is used for a lithium ion secondary battery containing a graphite-based carbon material as a negative electrode active material, and contains:
a nonaqueous solvent; and a lithium salt dissolved in the nonaqueous solvent.
The nonaqueous solvent containing, as a main component, a solvent mixture of a cyclic carbonate and a cyclic ester.
The proportion of the solvent mixture in a total amount of the nonaqueous solvent is 85 vol % or more.
The proportion of the cyclic carbonate in the sum of the solvent mixture is 60 vol % or more to 95 vol % or less.

In the electrolyte, the nonaqueous solvent contains, as a main component, a solvent mixture of a cyclic carbonate and a cyclic ester, and the proportion of the cyclic carbonate in this solvent mixture is high (60 vol % or more to 95 vol % or less). This is advantageous in reduction of volatilization of the nonaqueous solvent and improvement in charge-discharge characteristics in a wide temperature range. The proportion of the cyclic carbonate in the sum of cyclic carbonate and the cyclic ester is preferably 70 vol % or more, more preferably 80 vol % or more.

In one embodiment, in a structure optimized by a DFT method (functional: B3LYP, basis set: 6-31G) for the solvent mixture, an interaction energy of an assembly of five molecules extracted from a result of energy calculated by the DFT method (functional: B3LYP, basis set: cc-pVDZ) is 21 kcal/mole or more, and
in each structure optimized by the DFT method (functional: B3LYP, basis set: 6-31G) for the solvent mixture, an arithmetic mean of a dipole moment of the cyclic carbonate and a dipole moment of the cyclic ester obtained from a result of energy calculated by the DFT method (functional: B3LYP, basis set: cc-pVDZ) is 4.4D or more.

The interaction energy of the assembly of five molecules is specifically obtained as follows. The structure of each combination composed of a total of five molecules of the cyclic carbonate and the cyclic ester in each composition ratio is optimized by the DFT method (functional: B3LYP, basis set: 6-31G). An interaction energy of the assembly of five molecules in each composition ratio according to this optimized structure is extracted from a result of energy calculated by the DFT method (functional: B3LYP, basis set: cc-pVDZ). Then, on the basis of data according to each of the obtained interaction energies and the composition rations, linear interpolation is applied. The interaction energy is obtained in this manner. If two or more kinds of cyclic carbonate are employed as the cyclic carbonate, a cyclic carbonate having the highest concentration among the two or more kinds is regarded as a component of the solvent mixture. If two or more kinds of cyclic ester are employed as the cyclic ester, a cyclic ester having the highest concentration among the two or more kinds is regarded as a component of the solvent mixture.

According to this, the nonaqueous solvent has a large intermolecular interaction energy, i.e., a large intermolecular bonding force, thereby reducing volatilization. On the other hand, the larger the interaction energy is, the higher the viscosity of the nonaqueous solvent is. In contrast, in the present embodiment, the dipole moment (arithmetic mean) is increased to enhance the dissociation of Li ions. That is, Li ions are made easy to move. Accordingly, it is easy to ensure desired charge-discharge characteristics.

Regardless of the kinds of the cyclic carbonate and the cyclic ester and the optimized structure, the interaction energy is preferably 21 kcal/mol or more, more preferably 22 kcal/mol or more, yet more preferably 23 kcal/mol or more.

In one embodiment, the cyclic carbonate is propylene carbonate, and the cyclic ester is γ-butyrolactone.

Specifically, propylene carbonate as a solvent has a boiling point of 241.7° C., and γ-butyrolactone as a solvent has a boiling point of 206° C. The nonaqueous solvent contains, as main components, such solvents having high boiling points, which is advantageous in reduction of volatilization and improvement of safety.

In terms of charge-discharge characteristics, the ion conductivity of the electrolyte has been ensured by a combination of a solvent having a high dielectric constant and a solvent having a low viscosity. Propylene carbonate and γ-butyrolactone, which are components of the nonaqueous solvent, both have high dielectric constants and high viscosities, and propylene carbonate further has a low melting point (−49° C.) and has a property of being liquid at low temperatures. It is assumed that the combination of propylene carbonate and γ-butyrolactone increases ion conductivity and improves output characteristics for this reason.

Further, since the melting point of propylene carbonate is low as described above, an increase in resistance due to coagulation of the electrolyte is avoided even at low temperatures, which is advantageous in ensuring the performance of the battery at low temperatures.

For this reason, the electrolyte is used in a lithium ion secondary battery containing a graphite-based carbon material as a negative electrode active material, and even in the case of using graphite, high energy density can be maximally utilized without reducing the output.

In one embodiment, the graphite-based carbon material has a graphitization degree of 0.015 rad or more as a half-power band width of a diffraction peak at a diffraction angle 2θ=26.6° using a CuKα ray, and the nonaqueous solvent contains, as a SEI forming solvent, vinylene carbonate and/or fluoroethylene carbonate.

If cyclic carbonate and cyclic ester, specifically propylene carbonate and γ-butyrolactone, are employed as a nonaqueous solvent with the use of a graphite-based carbon material as a negative electrode active material, a solid electrolyte interface (SEI) layer is less prone to be formed, which is a problem. The SEI layer is formed by reduction and degradation of the solvent in the electrolyte while charging, and solvated Li ions are de-solvated when passing through the SEI layer and are then inserted between graphite layers individually. If the formation of the SEI layer is insufficient, the solvated Li ions are inserted directly between the graphite layers (co-insertion), the degradation reaction of the solvent proceeds between the graphite layers, and the crystal structure of graphite is broken, thereby reducing the cycle stability performance of the battery. The higher the graphitization degree is, the more advantageous the increase in battery capacity is. However, the problem of the co-insertion becomes significant.

In contrast, in the present embodiment, vinylene carbonate and/or fluoroethylene carbonate contained in the nonaqueous solvent serves as a SEI layer forming agent or a SEI layer repairing agent. Thus, the Li ions are de-solvated efficiently through the SEI layer, and the degradation reaction of the solvent between the graphite layers is substantially prevented, thereby improving the cycle stability performance

In a preferred embodiment, the proportion of the SEI forming solvent relative to the sum of the cyclic carbonate and the cyclic ester is 0.5 mass % or more to 5 mass % or less.

In one embodiment, the lithium ion secondary battery contains an iron phosphate-based lithium compound as a positive electrode active material.

The iron phosphate-based lithium compound has a high dissociation temperature of oxygen, which is advantageous in not only reduction of oxygen generation at high temperatures, but also improvement in cycle life of battery. For the nonaqueous solvent, ethylene carbonate is solid at normal temperatures, which is disadvantageous in improvement of the performance of the battery at low temperatures. Thus, the ethylene carbonate is preferably not added to the nonaqueous solvent.

Note that a small amount (for example, about 10 vol % to about 20 vol %) of ethylene carbonate can be added without reducing the output.

In one embodiment, the nonaqueous solvent contains dibutyl carbonate.

If cyclic carbonate and cyclic ester, which are main components of the nonaqueous solvent, have high viscosities, wettability to the separator is low. Thus, dibutyl carbonate is added to improve wettability of the electrolyte to the separator. Dibutyl carbonate, which has a high boiling point (about 206° C.), is particularly preferred from the viewpoint of reducing volatilization of the nonaqueous solvent.

### Advantages of the Invention

In the nonaqueous electrolyte according to the present invention for a lithium ion secondary battery containing a graphite-based carbon material as a negative electrode active material, a nonaqueous solvent contains cyclic carbonate and cyclic ester, and the proportion of the sum of the cyclic carbonate and the cyclic ester in the total amount of the nonaqueous solvent is 85 vol % or more, and the proportion of the cyclic carbonate in the sum of the cyclic carbonate and the cyclic ester is 60 vol % or more to 95 vol % or less. This is advantageous in reduction of volatilization of the nonaqueous solvent and improvement in charge-discharge characteristics in a wide temperature range.

### BRIEF DESCRIPTION OF THE DRAWINGS

FIG. 1 is a graph illustrating a relationship between a PC concentration and a coulombic efficiency in the case in which a negative electrode active material is natural graphite.

FIG. 2 is a graph illustrating a relationship between a PC concentration and a coulombic efficiency in the case in which a negative electrode active material is artificial graphite.

FIG. 3 is a graph illustrating a relationship between a VC concentration and a charge resistance.

FIG. 4 is a graph illustrating a relationship between a VC concentration and a discharge resistance.

FIG. 5 is a graph illustrating a relationship between a FEC concentration and a charge resistance.

FIG. 6 is a graph illustrating a relationship between a FEC concentration and a discharge resistance.

FIG. 7 is a graph illustrating an effect on a charge resistance between positive electrode-reference electrode in each three-electrode cell by addition of VC to a nonaqueous electrolyte.

FIG. 8 is a graph illustrating an effect on a charge resistance between positive electrode-reference electrode in each three-electrode cell by addition of FEC to a nonaqueous electrolyte.

FIG. 9 is a graph illustrating an effect on a discharge resistance between positive electrode-reference electrode in each three-electrode cell by addition of VC to a nonaqueous electrolyte.

FIG. 10 is a graph illustrating an effect on a discharge resistance between positive electrode-reference electrode in each three-electrode cell by addition of FEC to a nonaqueous electrolyte.

FIG. 11 is a graph illustrating an effect on a charge resistance between negative electrode-reference electrode in each three-electrode cell by addition of VC to a nonaqueous electrolyte.

FIG. 12 is a graph illustrating an effect on a charge resistance between negative electrode-reference electrode in each three-electrode cell by addition of FEC to a nonaqueous electrolyte.

FIG. 13 is a graph illustrating an effect on a discharge resistance between negative electrode-reference electrode in each three-electrode cell by addition of VC to a nonaqueous electrolyte.

FIG. 14 is a graph illustrating an effect on a discharge resistance between negative electrode-reference electrode in each three-electrode cell by addition of FEC to a nonaqueous electrolyte.

FIG. 15 is a perspective view illustrating an aspect of a wettability test for an electrolyte to a separator.

FIG. 16 is a drawing illustrating an optimized structure of an assembly of five molecules (PC:GBL=5:0).

FIG. 17 is a drawing illustrating an optimized structure of an assembly of five molecules (PC:GBL=4:1).

FIG. 18 is a drawing illustrating an optimized structure of an assembly of five molecules (PC:GBL=3:2).

FIG. 19 is a drawing illustrating an optimized structure of an assembly of five molecules (PC:GBL=2:3).

FIG. 20 is a drawing illustrating an optimized structure of an assembly of five molecules (PC:GBL=1:4).

FIG. 21 is a drawing illustrating an optimized structure of an assembly of five molecules (PC:GBL=0:5).

FIG. 22 is a graph illustrating linear interpolation of interaction energies.

FIG. 23 is a graph illustrating a relationship between a GBL concentration and a flash point.

FIG. 24 is a graph illustrating a relationship between a DBC concentration and a flash point.

### DESCRIPTION OF EMBODIMENTS

Hereinafter, an embodiment of the present invention will be described with reference to the drawings. The following description of preferred embodiment is only an example in nature, and is not intended to limit the scope, applications or use of the present invention.

The present embodiment relates to an electrolyte for a lithium ion secondary battery and a lithium ion secondary battery using the electrolyte and is suitably applied to, for example, electronic devices, electric vehicles, and hybrid electric vehicles.

[Lithium Ion Secondary Battery]

A lithium ion secondary battery includes: a positive electrode having a lithium compound as a positive electrode active material; a negative electrode having a graphite-based carbon material as a negative electrode active material; a separator; and a nonaqueous electrolyte. The structure of the lithium ion secondary battery is not particularly limited, and the lithium ion secondary battery may be, for example, a coin-type battery, cylindrical battery, square battery, or laminate battery, having a single layer or multilayer separator.

[Positive Electrode]

A positive electrode is formed by mixing a positive electrode active material and assistants (a binder and a conductive assistant) and then applying the mixture to a collector. A preferred collector can be an aluminum foil.

A preferred positive electrode active material includes: a composite metal oxide of lithium and one or more kinds selected from the group consisting of cobalt, manganese, and nickel; a phosphoric acid-based lithium compound; and a silicic acid-based lithium compound.

In particular, a phosphoric acid-based lithium is suitably employed. These positive electrode active materials may be used alone or in a combination of two or more of them.

Examples of a preferred phosphoric acid-based lithium compound include LiMPO₄ (M=transition metal Fe, Co, Ni, Mn, and the like) in an olivine crystal structure and Li₂MPO₄F (M=transition metal Fe, Co, Ni, Mn, and the like). Among these, lithium iron phosphate LiFePO₄ is preferred. Examples of the silicic acid-based lithium compound include Li₂MSiO₄ (M=transition metal Fe, Co, Ni, Mn, and the like).

As the binder, polyvinylidene fluoride (PVdF) can be suitably employed. As the conductive assistant, any of carbon black, acetylene black, carbon nanofibers (CNFs), and the like can be employed.

[Negative Electrode]

A negative electrode is formed by mixing a negative electrode active material and assistants (a binder and a conductive assistant) and then applying the mixture to a collector. A preferred collector includes a copper foil.

As the negative electrode active material, a graphite-based carbon material such as artificial graphite or natural graphite can be suitably employed. As the graphite-based carbon material, one having a low graphitization degree is preferred from the viewpoint of improving an ability of storing and releasing Li ions. For example, the graphitization degree of the graphite-based carbon material is preferably 0.015 rad or more as a half-power band width of a diffraction peak at a diffraction angle 2θ=26.6° using a CuKα ray. Artificial graphite and hard carbon, each of which has a low graphitization degree, are suitable as a negative electrode active material, but the natural graphite alone has high crystallinity, thereby easily deteriorated. Thus, surface-treated natural graphite and artificial graphite are suitably used in combination.

As the binder, styrene-butadiene rubber (SBR), a combination (SBR-CMC) of styrene-butadiene rubber (SBR) and carboxymethylcellulose as a thickener, PVdF, an imide-based binder, or the like may be suitably employed. As the conductive assistant, carbon black, acetylene black, carbon nanofibers (CNFs), or the like can be suitably employed.

[Separator]

The separator is not particularly limited, and, for example, a microporous film, a woven fabric, a nonwoven fabric, or the like of a single layer or multilayer of polyolefin such as polypropylene and polyethylene can be employed.

[Nonaqueous Electrolyte]

The nonaqueous electrolyte is obtained by dissolving a lithium salt (support electrolyte) in a nonaqueous solvent, and an additive is added thereto as required.

The nonaqueous solvent is a solvent mixture, and from the viewpoint of improving charge-discharge characteristics in a wide temperature range, the interaction energy of an assembly of five molecules to be described later is preferably 21 kcal/mol or more, and the dipole moment (arithmetic mean) to be described later is preferably 4.4D or more.

It is preferred that the nonaqueous solvent contains, as a main component, a solvent mixture of a cyclic carbonate having a dipole moment of 5 debye (D) or more and a melting point of 0° C. or less and a cyclic ester having a dipole moment of 4D or more to less than SD and a melting point of 0° C. or less. The dipole moments are values obtained by a quantum chemical calculation to be described later.

In this case, the proportion of the solvent mixture in the total amount of the nonaqueous solvent is preferably 85 vol % or more, and the proportion of the cyclic carbonate in the total amount of this solvent mixture is preferably 60 vol % or more to 95 vol % or more, more preferably 70 vol % or more to 95 vol % or less from the viewpoint of increasing a discharge capacity and a charge capacity and improving coulombic efficiency.

The cyclic carbonate can be propylene carbonate (PC) having a relative permittivity of 64.4, a dipole moment of 5.21D, a melting point of −49° C., and a flash point of 132° C., and further can be butylene carbonate (BC). PC can be suitably employed.

The cyclic ester can be γ-butyrolactone (GBL) having a relative permittivity of 39.1, a dipole moment of 4.12D, a melting point of −42° C., and a flash point of 98° C., and further can be γ-valerolactone (GVL). GBL can be suitably employed.

The additive of the nonaqueous solvent includes a SEI forming solvent and a wettability improving solvent that improves wettability of the electrolyte to the separator.

The wettability improving solvent can be, for example, dibutyl carbonate (DBC), methylbutyl carbonate (MBC), and ethylbutyl carbonate (EBC). Among them, n-DBC having a high flash point (91° C.) is suitably employed.

The amount of the wettability improving solvent to be added is set such that the proportion of the wettability improving solvent in the sum of the cyclic carbonate and the cyclic ester is preferably 1 mass % or more to 10 mass % or less, more preferably 1 mass % or more to 5 mass % or less, yet more preferably 1 mass % or more to 4 mass % or less.

As the SEI forming solvent, a solvent which tends to form the SEI layer compared to cyclic carbonate and cyclic ester is employed. Thus, the SEI forming solvent preferably satisfies at least one of the condition where the LUMO energy at the negative electrode is lower than those of the cyclic carbonate and the cyclic ester or the condition where the HOMO energy at the positive electrode is higher than those of the cyclic carbonate and the cyclic ester.

The solvent satisfying at least one of the conditions can be, for example, vinylene carbonate (VC), methyl vinylene carbonate (MVC), ethyl vinylene carbonate (EVC), fluorovinylene carbonate (FVC), vinyl ethylene carbonate (VEC), ethynyl ethylene carbonate (EEC), ethylene sulfate (ES), and fluoroethylene carbonate (FEC), and VC or FEC can be suitably employed. These SEI forming solvents may be used alone or in a combination of two or more of them.

The amount of the SEI forming solvent to be added is preferably 0.5 mass % or more to 5 mass % or less as the proportion of the SEI forming solvent in the sum of the cyclic carbonate and the cyclic ester.

A preferred lithium salt includes LiPF₆, LiPO₂F₂, LiBF₄, LiN(SO₂F)₂, LiN(SO₂CF₃)₂, and LiN(SO₂C₂F₅)₂. The lithium salts may be used alone or in a combination of two or more of them.

The concentration of the lithium salt in the nonaqueous electrolyte may be, for example, 0.5M or more to 2.0M or less.

### EXAMPLES

Hereinafter, examples of the nonaqueous electrolyte according to the present invention will be described, but the present invention is not limited to these examples.

[Evaluation of Charge-Discharge Characteristics]

A graphite-based carbon material (negative electrode active material) and carbon black (conductive assistant) were mixed, and a binder solution previously obtained by dissolving

SBR-CMC (binder) was then added to the mixture and mixed. Thus, a negative electrode mixture paste was prepared. This negative electrode mixture paste was applied to a surface of a copper foil (collector), then dried, and pressurized. Thus, a negative electrode was produced. Using this negative electrode, a positive electrode (counter electrode) formed of a metal Li, and an electrolyte containing each nonaqueous solvent described in Table 1 (support electrolyte; LiPF₆=1M), each bipolar half cell for evaluation was produced. Then, coulombic efficiency was measured for each of natural graphite and artificial graphite as the negative electrode active material. In Table 1, “mass %” indicates the proportion of the solvent in the sum of PC and GBL. The same applies to Tables 2 to 4 and 6 to be described later.

TABLE 1

| Solvent | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| PC | 0 | 20 | 50 | 60 | 70 | 80 | 90 | 100 | 50 |
| (vol %) | | | | | | | | | |
| GBL | 100 | 80 | 50 | 40 | 30 | 20 | 10 | 0 | 50 |
| (vol %) | | | | | | | | | |
| DBC | 5 | 5 | 5 | 5 | 5 | 5 | 5 | 5 | 0 |
| (mass %) | | | | | | | | | |

Charging was performed by constant-current constant-voltage charging at a current value of 1 mA and a cut-off voltage of 0.01 V. Discharging was performed by constant-current discharging at a current value of 1 mA and a cut-off voltage of 2 V.

For natural graphite, the weight of the negative electrode was 306 mg, and the amount of the active material was 52 mg. For artificial graphite, the weight of the negative electrode was 233 mg, and the amount of the active material was 92 mg. The theoretical capacity was 372 mAh/g. The natural graphite used had a graphitization degree of 0.04356 rad as a half-power band width of a diffraction peak at a diffraction angle 20=26.6° using a CuKα ray. The artificial graphite used had a graphitization degree of 0.02558 as the same half-power band width.

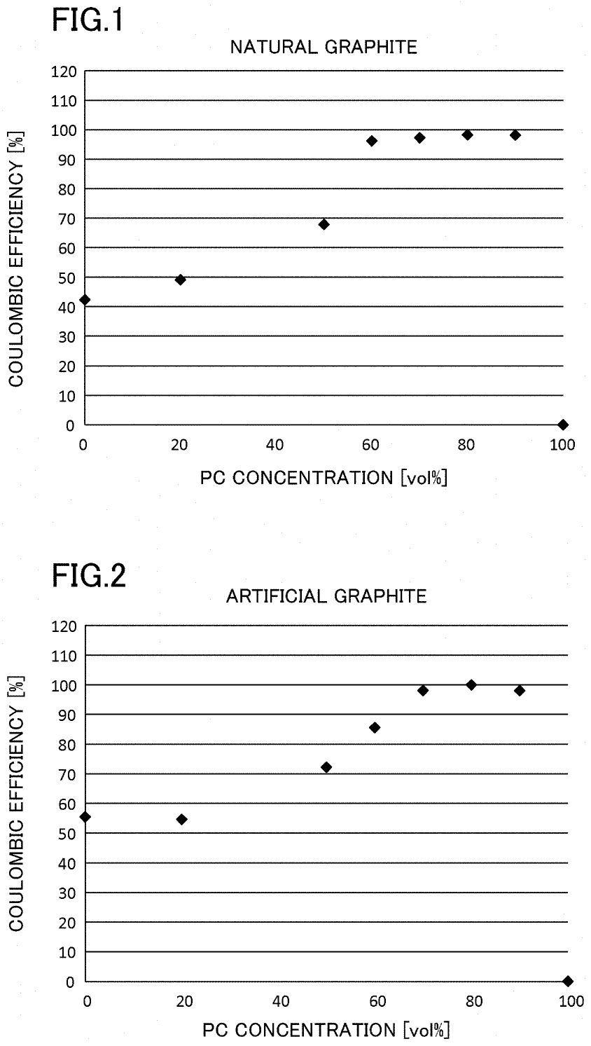

The measurement results (relationship between the PC concentration and the coulombic efficiency at the third cycle after production of each half cell) are shown in FIGS. 1 and 2. For the natural graphite, the coulombic efficiency was approximately 100% when the PC concentration was 60 vol % or more to 90 vol % or less. For the artificial graphite, the coulombic efficiency was approximately 100% when the PC concentration was 70 vol % or more to 90 vol % or less.

[Evaluation of Input-Output Characteristics With Addition of VC]

LiFePO₄ (positive electrode active material) and carbon black (conductive assistant) were mixed, and a binder solution previously obtained by dissolving PVdF (binder) was then added to the mixture and mixed. Thus, a positive electrode mixture paste was prepared. This positive electrode mixture paste was applied to a surface of an aluminium foil (collector), then dried, and pressurized. Thus, a positive electrode was produced. Natural graphite (negative electrode active material) and carbon black (conductive assistant) were mixed, and a binder solution previously obtained by dissolving SBR-CMC (binder) was then added to the mixture and mixed. Thus, a negative electrode mixture paste was prepared. This negative electrode mixture paste was applied to a surface of a copper foil (collector), then dried, and pressurized. Thus, a negative electrode was produced. The positive electrode, the microporous polypropylene film (separator), and the negative electrode were stacked in this order, and an electrolyte (support electrolyte; LiPF₆=1M) containing each nonaqueous solvent in composition described in Table 2 was added to the laminate. Thus, each full cell for evaluation was produced.

TABLE 2

| Solvent | Ex. 11 | Ex. 12 | Ex. 13 | Ex. 14 | Ex. 15 | Ex. 16 |
|---|---|---|---|---|---|---|
| PC (vol %) | 80 | 80 | 80 | 80 | 80 | 80 |
| GBL (vol %) | 20 | 20 | 20 | 20 | 20 | 20 |
| DBC (mass %) | 5 | 5 | 5 | 5 | 5 | 5 |
| VC (mass %) | 0 | 0.5 | 1 | 3 | 5 | 10 |

—Measurement of Charge Resistance and Discharge Resistance—

Each cell was charged 50% of its capacity, was placed in an environment of −30° C. Five current values (0.01C to 0.1 C) were then applied to the cell for each predetermined time (1 sec, 10 sec, 30 sec), and each charge (discharge) resistance was calculated from the relationship between each current value and the voltage measured after each predetermined time.

—Measurement Results—

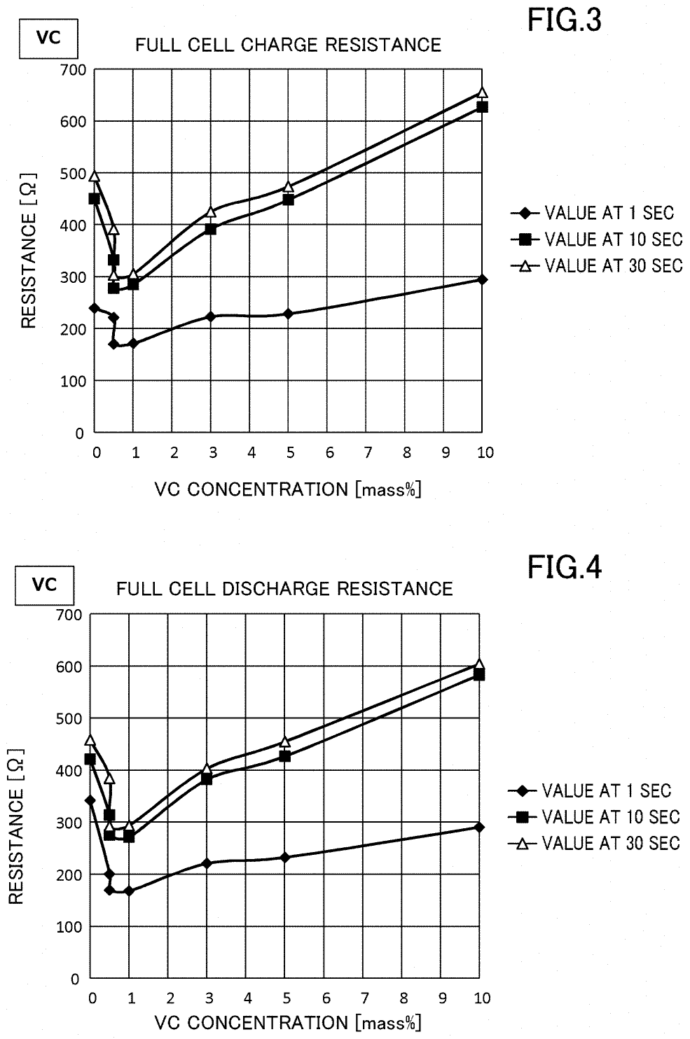

As shown in the measurement results of the charge resistance of FIG. 3, the charge resistance was considerably reduced by addition of a trace amount of VC (0.5 mass %, 1.0 mass %) and was then increased as the increase in amount of VC added. As shown FIG. 4, the discharge resistance was considerably reduced by addition of a trace amount of VC (0.5 mass %, 1.0 mass %) and was then increased as the increase in amount of VC added.

As can be seen from FIGS. 3 and 4, the amount of VC added of 5 mass % or less reduces the internal resistance (particularly the interface resistance) compared to the case of no addition of VC. It can be understood that the amount of VC to be added is preferably 0.5 mass % or more to 5 mass % or less, more preferably 3 mass % or less, yet more preferably 1 mass % or less.

[Evaluation of Input-Output Characteristics with Addition of FEC]

A positive electrode, a microporous polypropylene film (separator), and a negative electrode, which are the same as those in the case of adding VC, were produced and stacked, and an electrolyte (support electrolyte; LiPF₆=1M) containing each nonaqueous solvent in composition described in Table 3 was added to the laminate. Thus, each full cell for evaluation was produced. Then, the charge resistance and the discharge resistance were measured in the same manner as in the section [Evaluation of Input-Output Characteristics with Addition of VC]

TABLE 3

| Solvent | Ex. 21 | Ex. 22 | Ex. 23 | Ex. 24 | Ex. 25 | Ex. 26 |
|---|---|---|---|---|---|---|
| PC (vol %) | 80 | 80 | 80 | 80 | 80 | 80 |
| GBL (vol %) | 20 | 20 | 20 | 20 | 20 | 20 |
| DBC (mass %) | 5 | 5 | 5 | 5 | 5 | 5 |
| FEC (mass %) | 0 | 0.5 | 1 | 3 | 5 | 10 |

—Measurement Results—

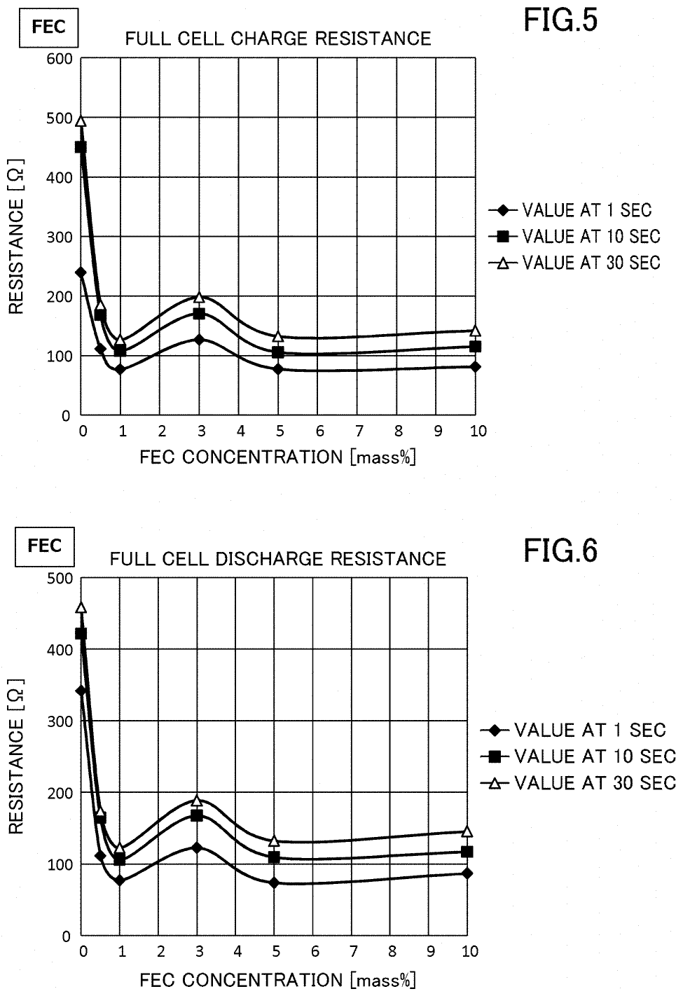

As shown in the measurement results of the charge resistance of FIG. 5, the charge resistance was considerably reduced by addition of a trace amount of FEC (0.5 mass %, 1.0 mass %) and was then still low even when the amount of FEC added was increased. As shown in FIG. 6, the discharge resistance was also considerably reduced by addition of a trace amount of FE (0.5 mass %, 1.0 mass %) and was then still low even when the amount of FEC added was increased.

As can be seen from FIGS. 5 and 6, the amount of FEC added of 5 mass % or less reduces the interface resistance compared to the case in which FEC is not added.It can be understood that the amount of FEC to be added is preferably 0.5 mass % or more to 5 mass % or less, more preferably 3 mass % or less from the viewpoint of cost reduction.

[Comparison Between VC and FEC]

A positive electrode, a microporous polypropylene film (separator), and a negative electrode, which are the same as those in the section [Evaluation of Input-Output Characteristics with Addition of VC], were produced, and a reference electrode, the separator, the positive electrode, the separator, and a negative electrode were stacked in this order. Then, each three-electrode cell containing an electrolyte (support electrolyte: LiPF6) which contains each VC-containing nonaqueous solvent shown in Table 2 (addition of VC), and each three-electrode cell containing an electrolyte (support electrolyte: LiPF₆) which contains each FEC-containing nonaqueous solvent shown in Table 3 were produced.

Thereafter, the charge resistance and discharge resistance between the positive electrode-reference electrode and the charge resistance and discharge resistance between the negative electrode-reference electrode were measured in the same manner as in the section [Evaluation of Input-Output Characteristics with Addition of VC] described above, using the three-electrode cell (addition of VC) and the three-electrode cell (addition of FEC).

—Measurement Results—

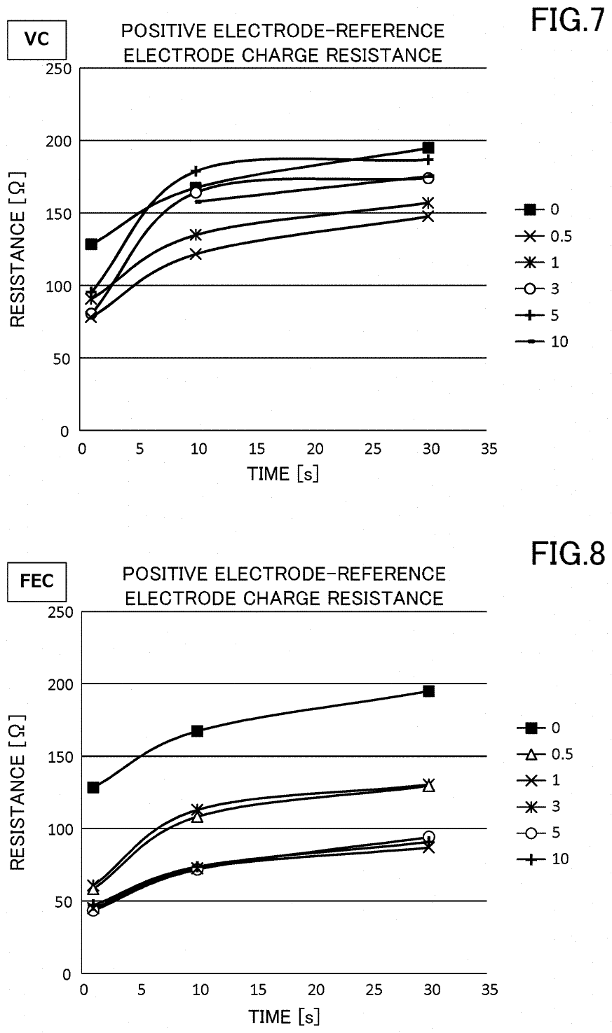

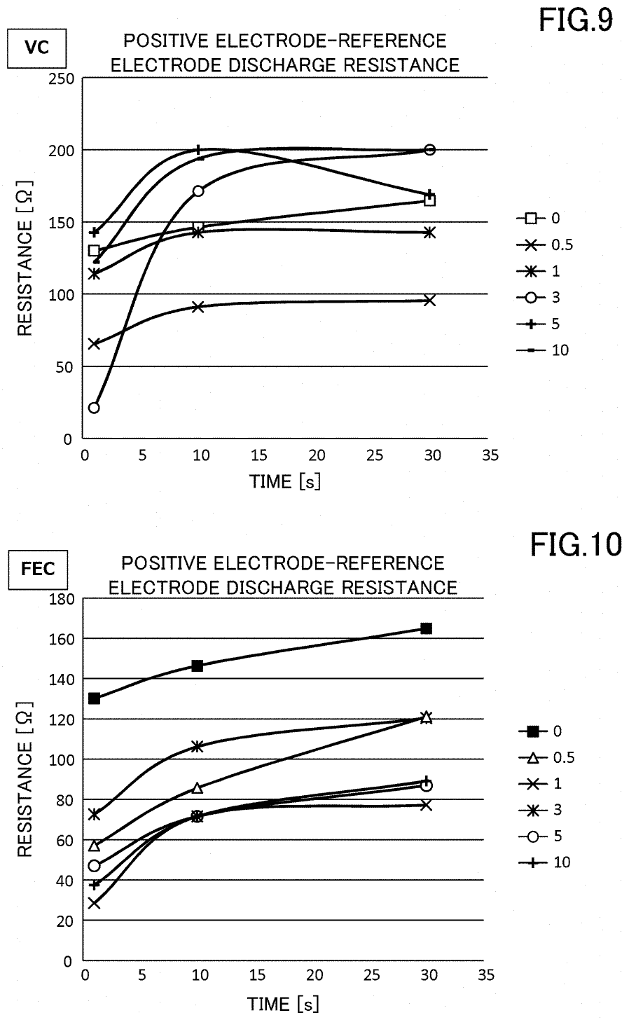

As shown in FIGS. 7 and 8, the charge resistance between the positive electrode-reference electrode was considerably reduced with addition of FEC compared to addition of VC. As shown in FIGS. 9 and 10, the discharge resistance between the positive electrode-reference electrode was also considerably reduced with addition of FEC compared to addition of VC.

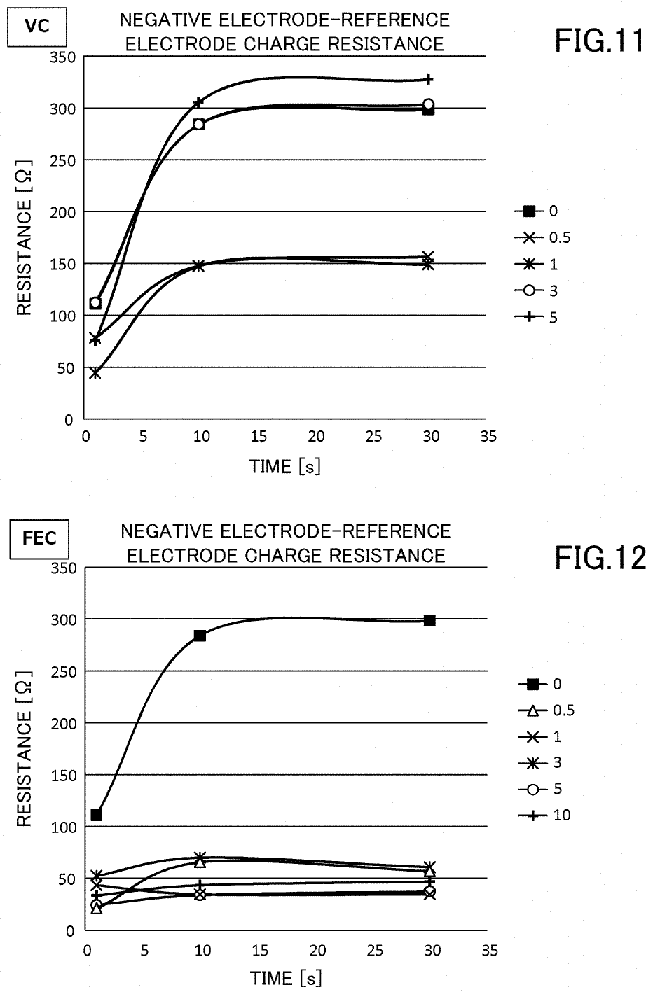

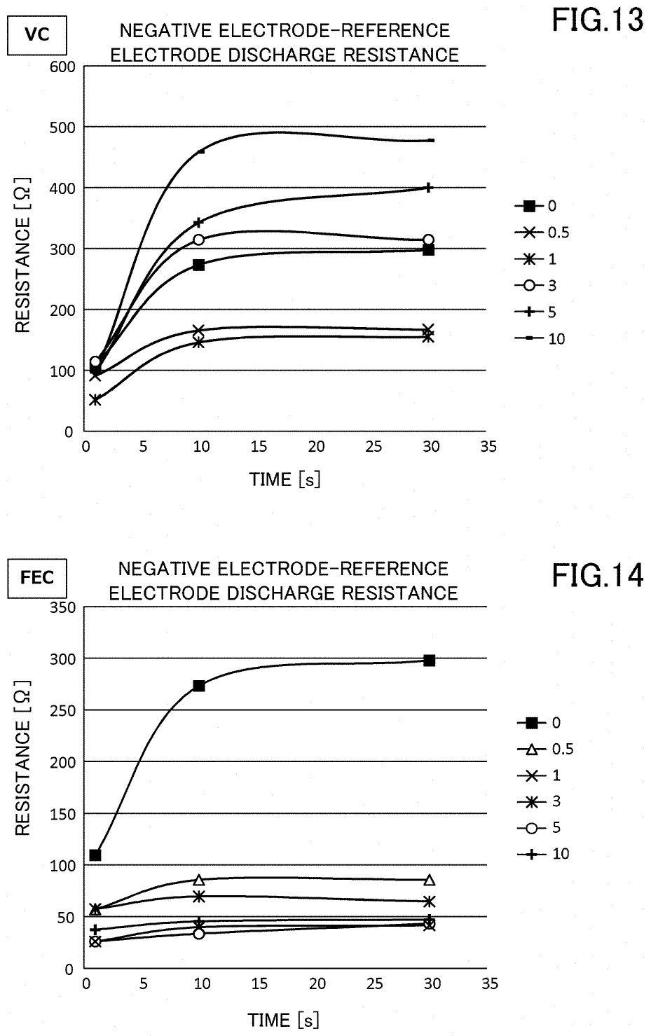

Further, as shown in FIGS. 11 and 12, the charge resistance between negative electrode-reference electrode was considerably reduced with addition of FEC compared to addition of VC. As shown in FIGS. 13 and 14, the discharge resistance between negative electrode-reference electrode was also considerably reduced with addition of FEC compared to addition of VC.

As can be seen from the above results, the addition of FEC to a nonaqueous electrolyte allows the interface resistance to be reduced compared to the addition of VC. That is, if a graphite-based carbon material is employed as a negative electrode active material, VC and/or FEC, particularly FEC is preferably added, as a SEI forming solvent, to a nonaqueous electrolyte.

[Evaluation of Improvement in Wettability]

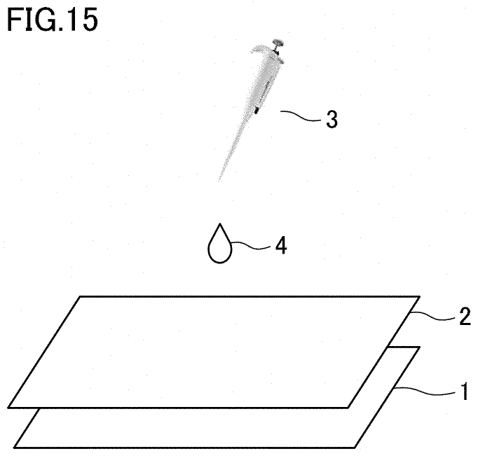

Wettability of each of electrolytes (support electrolyte: LiPF₆=1M) containing the respective nonaqueous solvents shown in Table 4 to a separator was evaluated. As shown in FIG. 15, the evaluation was performed by stacking a separator 2 on a plastic plate 1, dropwise adding 250 μL of an electrolyte 4 on the separator 2 with a pipette 3, and measuring time required for immersion of the electrolyte 4 into the separator 2. As the separator, a microporous polypropylene film was used.

The results are shown in Table 4. In Table 4, “Good” indicates that time required for the immersion is short, and wettability is sufficient, and “Poor” indicates that time required for the immersion is long, and wettability is insufficient.

TABLE 4

| | Amount of Wettability Improving | | | | |
|---|---|---|---|---|---|
| Volume Ratio | Solvent DBC Added (mass %) | | | | |
| of Solvents | 0 | 1 | 3 | 5 | 10 |
| EC:DEC = 30:70 | Good | — | — | — | — |
| PC:GBL = 20:80 | Poor | Poor | Good | Good | Good |
| PC:GBL = 50:50 | Poor | Poor | Good | Good | Good |
| PC:GBL = 80:20 | Poor | Poor | Good | Good | Good |
| EC:GBL = 50:50 | Poor | Poor | Good | Good | Good |

As can be seen from the columns indicated by “0” for the amount of DBC added, the combinations of PC and GBL and the combination of EC and GBL showed poor wettability to the separator. In contrast, wettability to the separator was improved as the increase in amount of DBC added in these combinations. As can be seen from Table 4, the amount of DBC to be added relative to the sum of PC and GBL is preferably 3 mass % or more to 10 mass % or less.

[Interaction Energy and Dipole Moment of Nonaqueous Solvent]

An interaction energy and a dipole moment (arithmetic mean) of each of the nonaqueous solvents (solvent mixtures of PC and GBL, single PC solvent) in the respective compositions shown in Table 5 were determined using Gaussian, which is a program for quantum chemical calculation.

TABLE 5

| | Ex. 31 | Ex. 32 | Ex. 33 | Ex. 34 | Ex. 35 | Ex. 36 | Ex. 37 |
|---|---|---|---|---|---|---|---|
| PC (vol %) | 20 | 40 | 50 | 60 | 70 | 80 | 90 |
| GBL (vol %) | 80 | 60 | 50 | 40 | 30 | 20 | 10 |
| Interaction Energy | 18.36 | 19.92 | 20.70 | 21.48 | 22.26 | 23.04 | 23.82 |
| (−kcal/mol) | | | | | | | |
| Arithmetic Average | 4.68 | 4.87 | 4.97 | 5.07 | 5.16 | 5.26 | 5.36 |
| of Dipole Moments (D) | | | | | | | |

The interaction energy was calculated by Gaussian as follows. First, initial coordinates of each combination composed of molecules of PC and GBL (total of five molecules) to be arranged in a three-dimensional space were set, and calculations were performed for optimizing each structure by a Hartree-Fock method using 6-31G as a basis set. On the basis of the calculation results, calculations for structure optimization were performed by a DFT method using B3LYP designated as a functional and 6-31G as a basis set. On the basis of the calculation result, an energy in the optimized structure was calculated by the DFT method using cc-pVDZ as a basis set (functional: B3LYP). On the basis of the calculation results, the interaction energy of each assembly of five molecules was extracted.

Combinations of five molecules set at initial coordinates are following six patterns A to F.

A; PC:GBL=5:0

B; PC:GBL=4:1

C; PC:GBL=3:2

D; PC:GBL=2:3

E; PC:GBL=1:4

F; PC:GBL=0:5

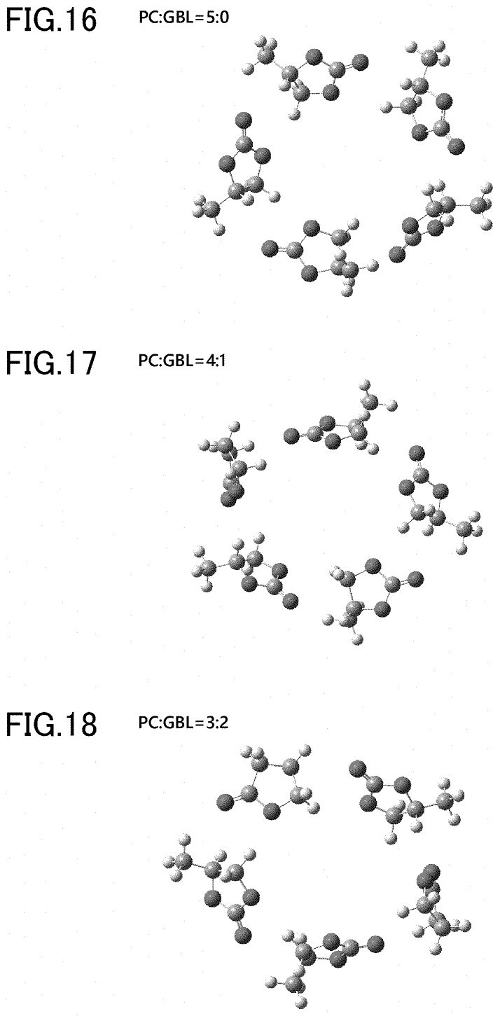

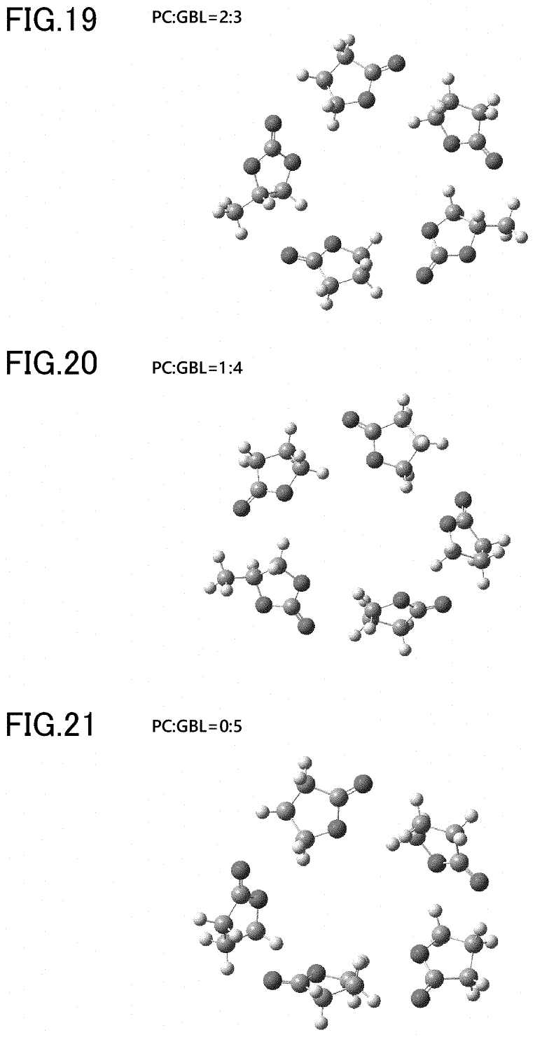

The structures of the combinations of five molecules of PC and GBL in total in the respective composition ratios were optimized by a DFT method (functional: B3LYP, basis set: 6-31G), and energies of assemblies of five molecules in the respective composition ratios, having the optimized structures were calculated by the DFT method (functional: B3LYP, basis set: cc-pVDZ), and on the basis of the calculation results, the interaction energy was extracted. FIGS. 16 to 21 show optimized structures of the respective patterns A to F. In FIGS. 16 to 21, gray spheres represent carbon, black spheres represent oxygen, and white small spheres represent hydrogen.

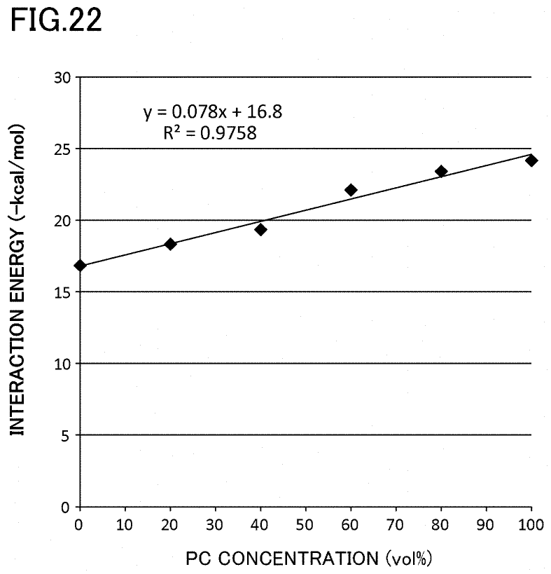

The interaction energies of Examples 31 to 37 shown in Table 5 were calculated by linear interpolation using the calculation results of the interaction energies of the six patterns A to F, i.e., data of the interaction energies and the composition ratios. FIG. 22 is a linearly interpolated graph of interaction energies.

The dipole moment (arithmetic mean) was calculated by Gaussian as follows. First, initial coordinates of a single PC molecule to be arranged in a three-dimensional space were set, and a calculation was performed for optimization by a Hartree-Fock method using 6-31G as a basis set. On the basis of the calculation result, a calculation for optimization was performed by a DFT method using B3LYP designated as a functional and 6-31G as a basis set. On the basis of the calculation result, an energy in the optimized structure was calculated by the DFT method using cc-pVDZ as a basis set (functional: B3LYP). On the basis of the calculation result, a dipole moment of the single PC molecule was determined. In the same manner, a dipole moment of a single GBL molecule was determined.

The arithmetic means of the dipole moment of a single PC molecule and the dipole moment of a single GBL molecule for each nonaqueous solvent in the composition shown in Table 5 was determined as a dipole moment (arithmetic mean).

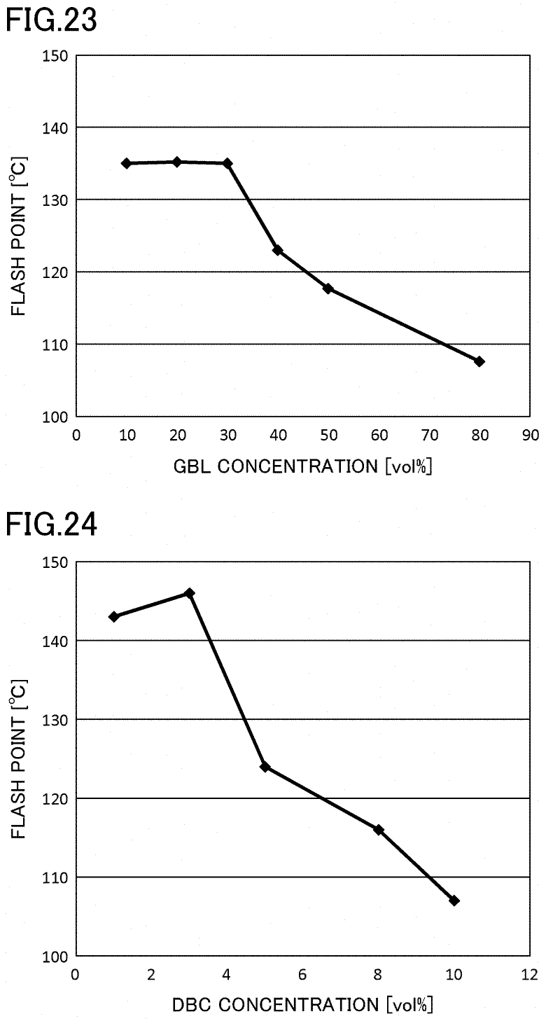

Electrolytes (support electrolytes: LiPF₆=1M) containing the respective nonaqueous solvents of Examples 31 and 33 to 37 shown in Table 5 were prepared, and the flash point of each of the electrolytes was measured. The measurement results are shown in FIG. 23. In the case in which the GBL concentration was 40 vol % or less (PC concentration: 60 vol % or more, interaction energy: 22 kcal/mol or more), the flash point was 120° C. or more. In the case in which the GBL concentration was 30 vol % or less (PC concentration: 70 vol % or more, interaction energy: 22.5 kcal/mol or more), the flash point was 130° C. or more.

The dipole moment (arithmetic mean) of each nonaqueous solvent shown in Table 5 was 4.4D or more, in particular, in Examples 29 to 32 in which the GBL concentration was 40 vol % or less (PC concentration: 60 vol % or more), the dipole moment (arithmetic mean) was SD or more, which is advantageous in obtaining a lithium ion secondary battery having superior charge-discharge characteristics. For example, as can be seen from FIGS. 1 and 2, in the case in which the GBL concentration was 40 vol % or less (PC concentration: 60 vol % or more), charge-discharge characteristics were excellent, and as can be seen from FIGS. 3 and 4 (showing charge-discharge characteristics at −30° C. in the case in which the PC concentration was 80 vol %), charge-discharge characteristics were excellent at cryogenic temperatures. These results were caused by the large dipole moment (arithmetic mean) of each nonaqueous solvent.

The inventors of the present invention have found that in the case in which the nonaqueous solvent has a dipole moment (arithmetic mean) of 4.4D or more, an ion conductivity in 1M LiPF₆ is 1.4 mS/cm or more.

[Ratio of DBC to be Added and Flash Point]

Electrolytes (support electrolytes; LiPF₆=1M) containing the respective nonaqueous solvents (solvent mixtures of PC, GBL, and DBC) in the compositions shown in Table 6 were prepared, and the flash point of each of the electrolyte was measured.

TABLE 6

| Solvent | Ex. 41 | Ex. 42 | Ex. 43 | Ex. 44 | Ex. 45 |
|---|---|---|---|---|---|
| PC (vol %) | 80 | 80 | 80 | 80 | 80 |
| GBL (vol %) | 20 | 20 | 20 | 20 | 20 |
| DBC (mass %) | 1 | 3 | 5 | 8 | 10 |

The measurement results of the flash points are shown in FIG. 24. In the case in which the DBC concentration was 5 mass % or less, the flash point was 120° C. In FIG. 24, in the case in which the DBC concentration was 4 mass % or less, the flash point was expected to be 130° C. or more.

### [Others]

The solvent mixture according to the present invention is a combination of a cyclic carbonate and a cyclic ester, and for a combination of a cyclic solvent and a chain solvent and a combination of chain solvent and a chain solvent, the interaction energies and the dipole moments can also be determined by the method.

### DESCRIPTION OF REFERENCE CHARACTERS

1 Plastic Plate
2 Separator
3 Pipette
4 Electrolyte

1. An electrolyte for a lithium ion secondary battery that contains a graphite-based carbon material as a negative electrode active material, the electrolyte comprising:
a nonaqueous solvent; and a lithium salt dissolved in the nonaqueous solvent,
the nonaqueous solvent containing, as a main component, a solvent mixture of a cyclic carbonate and a cyclic ester,
the proportion of the solvent mixture in a total amount of the nonaqueous solvent being 85 vol % or more, and
the proportion of the cyclic carbonate in a sum of the solvent mixture being 60 vol % or more to 95 vol % or less.

2. The electrolyte of claim 1, wherein
in a structure optimized by a DFT method (functional: B3LYP, basis set: 6-31G) for the solvent mixture, an interaction energy of an assembly of five molecules extracted from a result of energy calculated by the DFT method (functional: B3LYP, basis set: cc-pVDZ) is 21 kcal/mole or more, and
in each structure optimized by the DFT method (functional: B3LYP, basis set: 6-31G) for the solvent mixture, an arithmetic mean of a dipole moment of the cyclic carbonate and a dipole moment of the cyclic ester obtained from a result of energy calculated by the DFT method (functional: B3LYP, basis set: cc-pVDZ) is 4.4D or more.

3. The electrolyte of claim 1, wherein the cyclic carbonate is propylene carbonate, and the cyclic ester is γ-butyrolactone.

4. The electrolyte of any one of claim 1, wherein the graphite-based carbon material has a graphitization degree of 0.015 rad or more as a half-power band width of a diffraction peak at a diffraction angle 2θ=26.6° using a CuKα ray, and
the nonaqueous solvent contains, as a SEI forming solvent, vinylene carbonate and/or fluoroethylene carbonate.

5. The electrolyte of claim 4, wherein
the proportion of the SEI forming solvent relative to a sum of the cyclic carbonate
and the cyclic ester is 0.5 mass % or more to 5 mass % or less.

6. The electrolyte of claim 1, wherein
the lithium ion secondary battery contains an iron phosphate-based lithium compound as a positive electrode active material, and
the nonaqueous solvent does not contain ethylene carbonate.

7. The electrolyte of claim 1, wherein
the nonaqueous solvent contains dibutyl carbonate.

8. A lithium ion secondary battery comprising: a positive electrode; a negative electrode; a separator; and an electrolyte obtained by dissolving a lithium salt in a nonaqueous solvent, wherein
the electrolyte is the electrolyte of claim 1.

9. The electrolyte of claim 3, wherein
the graphite-based carbon material has a graphitization degree of 0.015 rad or more as a half-power band width of a diffraction peak at a diffraction angle 2θ=26.6° using a CuKα ray, and
the nonaqueous solvent contains, as a SEI forming solvent, vinylene carbonate and/or fluoroethylene carbonate.

10. The electrolyte of claim 9, wherein
the proportion of the SEI forming solvent relative to a sum of the cyclic carbonate and the cyclic ester is 0.5 mass % or more to 5 mass % or less.

11. A lithium ion secondary battery comprising: a positive electrode; a negative electrode; a separator; and an electrolyte obtained by dissolving a lithium salt in a nonaqueous solvent, wherein
the electrolyte is the electrolyte of claim 7.

12. The electrolyte of claim 2, wherein
the cyclic carbonate is propylene carbonate, and the cyclic ester is γ-butyrolactone.

13. The electrolyte of claim 12, wherein
the graphite-based carbon material has a graphitization degree of 0.015 rad or more as a half-power band width of a diffraction peak at a diffraction angle 2θ=26.6° using a CuKα ray, and
the nonaqueous solvent contains, as a SEI forming solvent, vinylene carbonate and/or fluoroethylene carbonate.

14. The electrolyte of claim 13, wherein
the proportion of the SEI forming solvent relative to a sum of the cyclic carbonate and the cyclic ester is 0.5 mass % or more to 5 mass % or less.

15. The electrolyte of claim 14, wherein
the lithium ion secondary battery contains an iron phosphate-based lithium compound as a positive electrode active material, and
the nonaqueous solvent does not contain ethylene carbonate.

16. The electrolyte of claim 15, wherein
the nonaqueous solvent contains dibutyl carbonate.

17. A lithium ion secondary battery comprising: a positive electrode; a negative electrode; a separator; and an electrolyte obtained by dissolving a lithium salt in a nonaqueous solvent, wherein
the electrolyte is the electrolyte of claim 16.
